(19) United States
(12) Patent Application Publication
(10) Pub. No.: US 2026/0116277 A1
(43) Pub. Date: Apr. 30, 2026

(54) VOXEL BASED TECHNOLOGIES

(71) Applicant: Ford Global Technologies, LLC, Dearborn, MI (US)

(72) Inventors: David D. Friske, Wolverine Lake, MI (US); Keith Weston, Canton, MI (US); Michael Joseph Niksa, Royal Oak, MI (US)

(73) Assignee: Ford Global Technologies, LLC, Dearborn, MI (US)

(21) Appl. No.: 18/929,863

(22) Filed: Oct. 29, 2024

(51) Int. Cl. B60N 2/64

(52) U.S. Cl. CPC B60N 2/64

(57) ABSTRACT

A vehicle cushion component is comprised of a lattice cell structure comprising a plurality of rods and a plurality of nodes that cooperate to define a plurality of cells. The plurality of cells includes a plurality of dimensions, defined by a plurality of dimensions provided by the plurality of rods. The plurality of dimensions of the plurality of rods is modified in accordance with a scaling factor to adjust the plurality of dimensions of the plurality of cells to provide the lattice cell structure with a scaled stiffness gradient. The scaled stiffness gradient provides the vehicle cushion component with a touch surface for contact with a user of the vehicle cushion component wherein the touch surface has a variable degree of stiffness unique to the user. The scaling factor is derived from pressure map data reflecting a pressure applied to the lattice cell structure.

### FIELD OF THE DISCLOSURE

The present disclosure generally relates to a vehicle cushion component for use in a vehicle and more specifically, to a vehicle cushion component comprising a lattice cell structure that is provided with a scaled stiffness gradient to define a touch surface with a variable stiffness.

### BACKGROUND OF THE DISCLOSURE

The present concept provides a unique vehicle cushion component providing a touch surface with a variable stiffness that is defined through a scaled stiffness gradient of a lattice cell structure of the vehicle cushion component.

### SUMMARY OF THE DISCLOSURE

According to a first aspect of the present disclosure, a vehicle cushion component is provided, comprising a lattice cell structure, wherein the lattice cell structure is comprised of a plurality of rods and a plurality of nodes, wherein the plurality of rods and the plurality of nodes cooperate to define a plurality of cells. The plurality of cells includes a plurality of dimensions, wherein a dimension of the plurality of dimensions of one or more cells of the plurality of cells is modified in accordance with a scaling factor to define a stiffness gradient for the lattice cell structure.

Embodiments of the first aspect of the present disclosure can include any one or a combination of the following features:
The scaling factor is derived from data provided in a pressure map taken of the lattice cell structure.
The scaling factor is derived from data produced through a tuning process, wherein the tuning process compares the stiffness gradient of the lattice cell structure when coupled with one or more vehicle components with the stiffness gradient of the lattice cell structure when uncoupled from one or more vehicle components.
The scaling factor is derived from data provided in a pressure map taken of the lattice cell structure, wherein the pressure map is customized in accordance with a pressure applied by a user seated on the lattice cell structure of the vehicle cushion component.
The scaling factor is derived from data provided in a pressure map taken of the lattice cell structure, wherein the pressure map is generated in accordance with a statistical average pressure applied to the lattice cell structure by a sample of users within a customer demographic set.
The scaling factor is derived from data provided in a pressure map wherein the pressure map includes a maximum pressure applied to the lattice cell structure over a time interval.
The scaling factor is derived from data produced through a tuning process, wherein the tuning process compares the stiffness gradient of the lattice cell structure when coupled with one or more vehicle components with the stiffness gradient of the lattice cell structure when uncoupled from one or more vehicle components, wherein the one or more vehicle components comprises components of a vehicle seating assembly.
The scaling factor is derived from data produced through a tuning process, wherein the tuning process compares the stiffness gradient of the lattice cell structure when coupled with one or more vehicle components with the stiffness gradient of the lattice cell structure when uncoupled from one or more vehicle components, wherein the one or more vehicle components comprises a cover for the lattice cell structure.
One of the plurality of dimensions of the plurality of rods includes a diameter of each of the plurality of rods.
One of the plurality of dimensions of the plurality of rods includes a contact angle of each of the plurality of rods.
One of the plurality of dimensions of the plurality of rods includes a length of each of the plurality of rods.
The lattice cell structure is provided with the stiffness gradient through modifying a density of the lattice cell structure in accordance with the scaling factor.
The lattice cell structure is comprised of a plurality of layers, wherein the plurality of layers is comprised of the plurality of cells.
The lattice cell structure is generated through an additive manufacturing process.

According to a second aspect of the present disclosure, a method for manufacturing a vehicle cushion component includes the step of defining a vehicle pad package with an interior portion and filling the interior portion of the vehicle pad package with a lattice cell structure. Next, pressure is applied to the lattice cell structure. The pressure applied to the lattice cell structure is mapped to generate a pressure map. A scaling factor is generated from the pressure map taken of the lattice cell structure and the lattice cell structure is scaled in accordance with the scaling factor to provide the lattice cell structure with a stiffness gradient.

Embodiments of the second aspect of the present disclosure can include any one or a combination of the following features:
The scaling factor is derived from data provided in a pressure map taken of the lattice cell structure, wherein the pressure map is customized in accordance with a pressure applied by a user seated on the lattice cell structure of the vehicle cushion component.
The scaling factor is derived from data provided in a pressure map taken of the lattice cell structure, wherein the pressure map is generated in accordance with a statistical average pressure applied to the lattice cell structure by a sample of users within a customer demographic set.

According to a third aspect of the present disclosure a method for manufacturing a vehicle component includes the step of defining a vehicle pad package with an interior portion and filling the interior portion of the vehicle pad package with an additively manufactured lattice cell structure. Next, pressure is applied to the lattice cell structure. The pressure applied to the lattice cell structure is mapped to generate a pressure map. A scaling factor is generated from the pressure map taken of the lattice cell structure and the lattice cell structure is scaled in accordance with the scaling factor to provide the lattice cell structure with a stiffness gradient. Tuning data is generated from a comparison between a stiffness gradient of the lattice cell structure when coupled with one or more vehicle components and a stiffness gradient of the lattice cell structure when uncoupled from the one or more vehicle components. An updated scaling factor is generated in accordance with the tuning data and the scaling factor, and the stiffness gradient is updated with the updated scaling factor to provide the lattice cell structure with an updated stiffness gradient.

Embodiments of the third aspect of the present disclosure can include any one of the following features:
The lattice cell structure is scaled in accordance with either the scaling factor or the updated scaling factor by modifying a dimension of one or more of a plurality of cells that comprise the lattice cell structure.
The lattice cell structure is scaled in accordance with either the scaling factor or the updated scaling factor by modifying the density of the lattice cell structure.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of the vehicle cushion component.

FIG. 2 is a side view of the vehicle cushion component.

FIG. 3 is a perspective view of one cell of the plurality of cells of the lattice cell structure.

FIG. 4 is a schematic representation of a plurality of cells of the lattice cell structure.

FIG. 5 is a cross-sectional view of the vehicle cushion component of FIG. 2 taken at line I, showing a first embodiment of the stiffness gradient of the lattice cell structure.

FIG. 6 is a cross-sectional view of the vehicle cushion component of FIG. 2 taken at line I, showing a second embodiment of the stiffness gradient of the lattice cell structure.

FIG. 7 is a sectional view of the vehicle cushion component coupled with a vehicle seat base showing the reaction force generated by the lattice cell structure in response to a force exerted against the vehicle cushion component.

FIG. 8 is a close-up view of FIG. 5 taken at Line II.

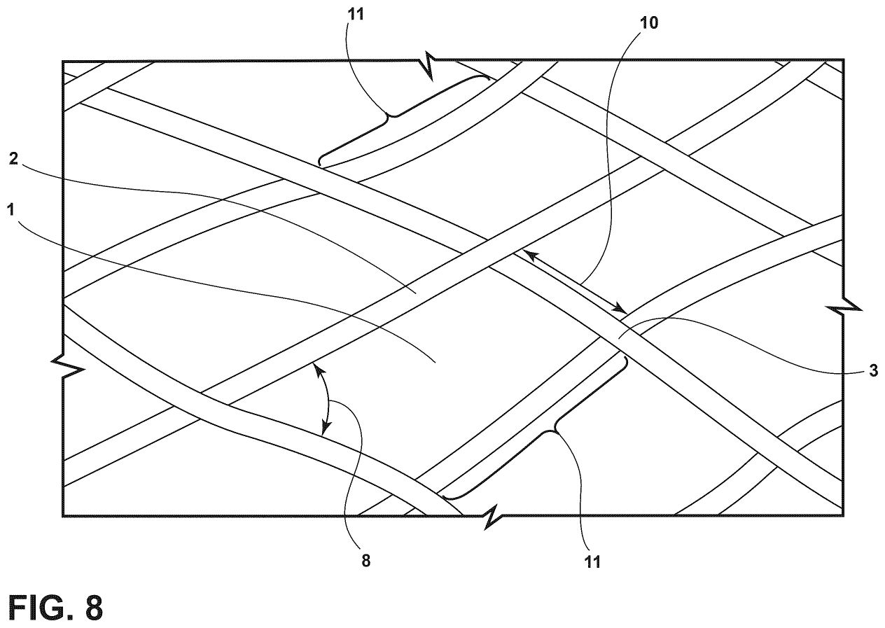

FIG. 9 is a close-up view of FIG. 6 taken at Line III.

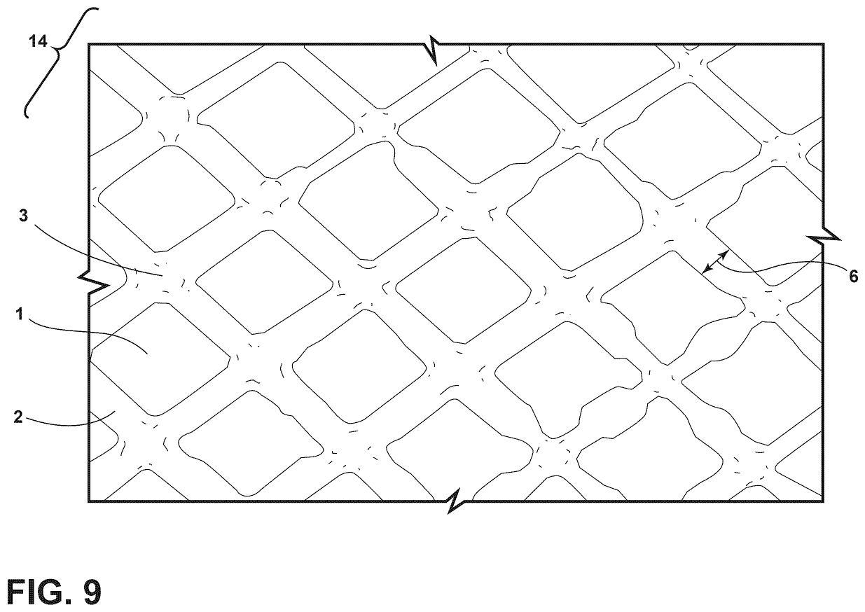

FIG. 10 is a top perspective view of the vehicle cushion component coupled with a vehicle seat base.

FIG. 11 is a diagram of a method of making a vehicle cushion component comprising a scaled lattice cell structure.

FIG. 12 is a diagram of another method of making a vehicle cushion component comprising a scaled lattice cell structure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

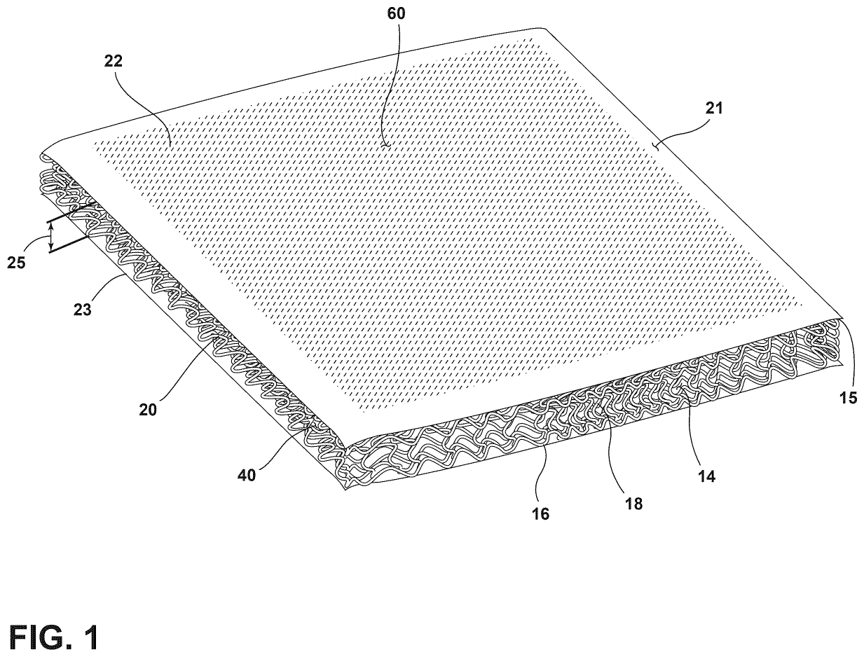

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an additively manufactured vehicle seat cushion comprising of a lattice cell structure which is further comprised of a plurality of cells. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring now to FIG. 1, a top perspective view of the vehicle cushion component 21 is shown. The vehicle cushion component 21 is comprised of a top cover 22 and a bottom cover 23 which cooperate to define an interior space 25 therebetween. A touch surface 60, configured to contact a user of the vehicle cushion component 21, is provided on an external surface of the top cover 22. A lattice cell structure 14 is positioned between the top cover 22 and the bottom cover 23 within the interior space 25. Specifically, the top cover 22 is coupled with a first surface 15 of the lattice cell structure 14 and the bottom cover 23 is coupled with a second surface 16 of the lattice cell structure 14. The lattice cell structure 14 is contemplated to be a flexible member configured to provide a variable degree of stiffness unique to each portion of the lattice cell structure 14 in response to a force exerted against the lattice cell structure 14. As used herein, the term “stiffness” refers to the tendency of a material to resist dimensional change when subjected to a force. In other words, the term “stiffness” refers to the tendency of a material to resiliently return to an original resting state after having been modified by an exerted force into a compressed state. Accordingly, the lattice cell structure 14 has a stiffness gradient 50, such that different portions of the lattice cell structure 14 exert unique responses to a force applied against the lattice cell structure 14. As such, various portions of the lattice cell structure 14 may be configured to compress at unique rates when the lattice cell structure 14 is subjected to an overall uniform force. It follows then that the stiffness gradient 50 of the lattice cell structure 14 provides to the touch surface 60 of the vehicle cushion component 21 a variable degree of stiffness. Accordingly, when a user exerts a force against the vehicle cushion component 21, the stiffness gradient 50 of the lattice cell structure 14 causes the lattice cell structure 14 to compress at different rates, thus allowing the user to experience a touch surface 60 of the vehicle cushion component 21 with a variable degree of stiffness.

The top cover 22 and the bottom cover 23 may be comprised of a leather, suede, polymeric, or vinyl material that is stretched and fitted to the dimensions of the lattice cell structure 14. Both the top cover 22 and the bottom cover 23 may be configured to possess a degree of elasticity, such that as force is applied to the vehicle cushion component 21 the top cover 22 and the bottom cover 23 stretch to both accommodate and be in accordance with the variable compression of the lattice cell structure 14. As such, it is contemplated that the interplay between the degree of elasticity of the top cover 22 and the stiffness gradient 50 of the lattice cell structure 14 cooperate to provide a touch surface 60 with a variable stiffness for contact with the user of the vehicle cushion component 21. Through these means, the vehicle cushion component 21 is configured to provide a variable degree of stiffness across the touch surface 60 of the vehicle cushion component 21. Further, it is also contemplated that the top cover 22 and the bottom cover 23 may be comprised of a common material of which the lattice cell structure 14 is also comprised, such that the top cover 22 and the bottom cover 23 and the lattice cell structure 14 may collectively define a monolithic structure.

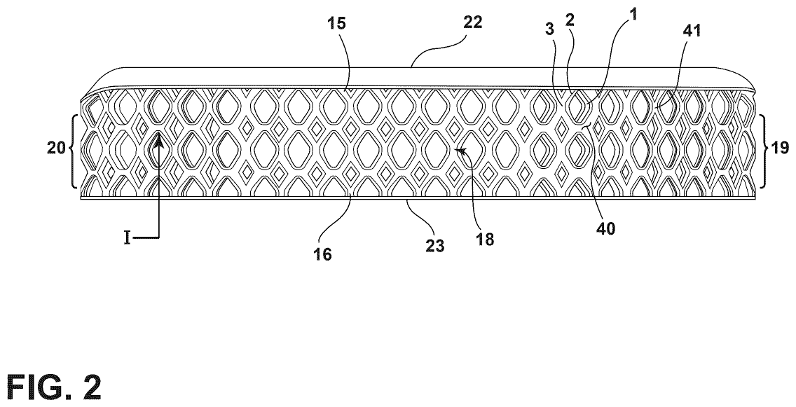

FIG. 2 shows a side view of the vehicle cushion component of FIG. 1. As shown in FIG. 1 and FIG. 2, the lattice cell structure 14 is comprised of a monolithic webbing 40. The monolithic webbing 40 is contemplated to be comprised of a build material constructed using an additive manufacturing technique, whereby a layer-by-layer deposition process is used to print or otherwise deposit, the build material. The build material may include a polymeric material that is cured after deposition. As such, the monolithic webbing 40 is contemplated to be a single, unitary and interconnected structure. The monolithic webbing 40 of the lattice cell structure 14 is further defined by a plurality of rods 2 and a plurality of nodes 3 that cooperate to define a plurality of cells 1.

Referring still to FIG. 2, each of the plurality of cells 1 is comprised of a plurality of rods 2 and a plurality of nodes 3 that cooperate to define each of the plurality of cells 1. Each cell of the plurality of cells 1 may be defined by the plurality of rods 2 and the plurality of nodes 3 wherein the plurality of rods 2 and the plurality of nodes 3 additionally define other cells of the plurality of cells 1. As such, each cell of the plurality of cells 1 is interconnected to other cells of the plurality of cells 1 through sharing the plurality of rods 2 and the plurality of nodes 3. Accordingly, the plurality of rods 2 and the plurality of nodes 3 cooperate to form a unitary composition defined by the plurality of cells 1.

As shown in FIG. 2, each of the plurality of rods 2 defines a segment of the monolithic webbing 40. Specifically, each of the plurality of rods 2 defines the segment of the monolithic webbing 40 that extends from an intersect point 41 formed by the monolithic webbing 40 to another intersect point 41 formed by the monolithic webbing 40. The intersect point 41 of the monolithic webbing 40 is the position where a strand of the monolithic webbing 40 intersects another strand of the monolithic webbing 40. As further shown in FIG. 2, each of the plurality of nodes 3 defines the intersect point 41 where a strand of the monolithic webbing 40 intersects another strand of the monolithic webbing 40. In other words, each of the plurality of nodes 3 is comprised of the portion of the monolithic webbing 40 where one of the plurality of rods 2 contacts another one of the plurality of rods 2. As such, each of the plurality of rods 2 extends from one of the plurality of nodes 3 until contacting another one of the plurality of nodes 3.

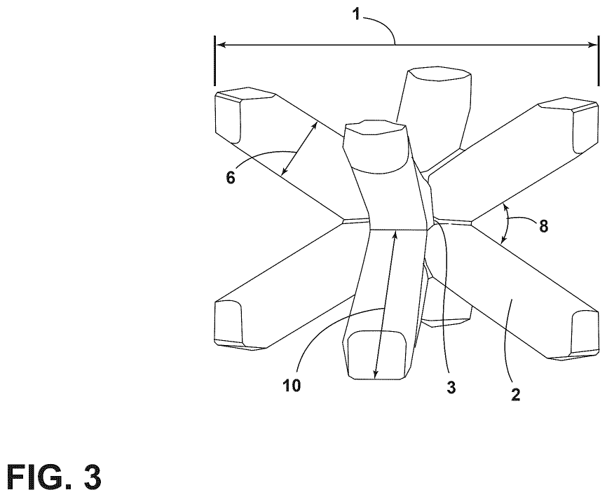

FIG. 3 is a perspective view of one cell of the plurality of cells 1 of the lattice cell structure 14 and shows a single node of the plurality of nodes 3 with a plurality of rods 2 extending from the single node of the plurality of nodes 3. Each of the plurality of rods 2 has a plurality of dimensions including a thickness dimension 6, a contact angle dimension 8, a length dimension 10, and a curvature dimension 11.

As shown in FIG. 3, the thickness dimension 6 of each of the plurality of rods 2 defines a diameter of each of the plurality of rods 2, such that by modifying the thickness dimension 6 of one or more of the plurality of rods 2, the diameter of one or more of the plurality of rods 2 is either increased or decreased. The thickness dimension 6 of each of the plurality of rods 2 may be increased in only a single direction. Additionally, the thickness dimension 6 of each of the plurality of rods 2 may be increased or decreased by varying amounts in multiple directions. Specifically, the thickness dimension 6 of one or more of the plurality of rods 2 may be increased or decreased in only a single direction defined in relation to a through-line that extends through a center of each of the plurality of rods 2 across the length dimension 10 of each of the plurality of rods 2. As such, it is contemplated that one or more of the plurality of rods 2 may have an asymmetric profile, wherein one or more of the plurality of rods 2 does not reflect an equivalent shape across the through-line of the or more of the plurality of rods 2. Additionally, it is contemplated that only a portion of one of the plurality of rods 2 may have an increased thickness dimension 6, such that one or more of the plurality of rods 2 comprises of one or more unique diameters. It is further contemplated that each of the plurality of rods 2 may have a unique set of diameters defined by a unique configuration of thickness dimensions 6.

As shown in FIG. 3, the contact angle dimension 8 is the angle located between two rods of the plurality of rods 2 at the position where the two rods of the plurality of rods 2 have made contact with one of the plurality of nodes 3. In other words, the contact angle dimension 8, is the angle located between two rods of the plurality of rods 2 at the position where each of the two rods 2 have contacted the other. It is contemplated that the contact angle dimension 8 may be increased or decreased between each of the plurality of rods 2.

As shown in FIG. 3, the length dimension 10 of each of the plurality of rods 2 is the distance each of the plurality of rods 2 extends from one of the plurality of nodes 3 to another one of the plurality of nodes 3. The length dimension 10 of each of the plurality of rods 2 may be configured to either increase or decrease providing a corresponding increase or decrease to a distance extending between each of the plurality of nodes 3.

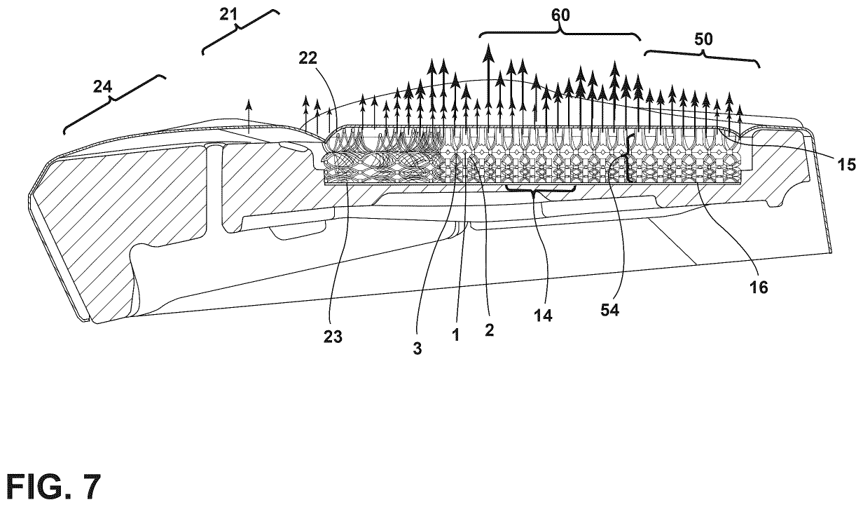

As shown in FIG. 7, the curvature dimension 11 of each of the plurality of rods 2 is the amount of deviation from a substantially straight line the one or more of a plurality of rods 2 exhibits as it extends from one of the plurality of nodes 3 to another one of the plurality of nodes 3. Specifically, as each of the plurality of rods 2 extends, each of the plurality of rods 2 may deviate from a path a substantially straight line would extend. As such, each of the plurality of rods 2 has a curvature dimension 11, wherein one or more of the plurality of rods 2 may extend in parallel to the path the substantially straight line would extend or the one or more of the plurality of rods 2 may deviate from the path the substantially straight line would extend such that one or more of the plurality of rods 2 are curved. It is contemplated that the curvature dimension 11 of each of the plurality of rods 1 may be adjusted to modify the degree of deviation from a substantially straight line.

It is contemplated that each of the plurality of dimensions of each of the plurality of rods 2 may be adjusted. Specifically, each of the plurality of dimensions of each of the plurality of rods 2 may be adjusted in combination, such that the plurality of dimensions of a set of the plurality of rods 2 are adjusted in the same manner. Additionally, it is contemplated that each of the plurality of dimensions of each of the plurality of rods 2 may be individually adjusted, such that each rod of the plurality of rods 2 is provided with a unique plurality of dimensions for demonstrating a desired deflection affect.

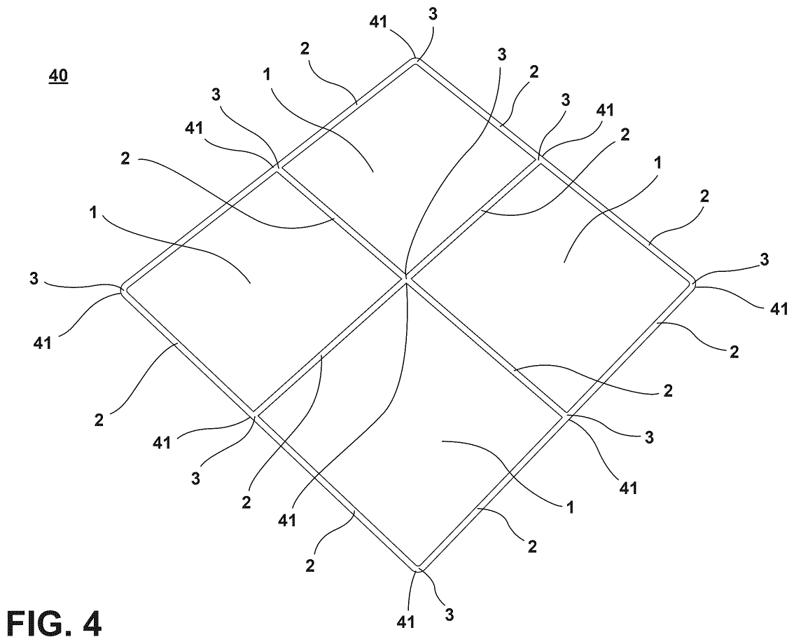

FIG. 4 shows a schematic representation of a plurality of cells 1 of the lattice cell structure 14. As shown in FIG. 4, the plurality of dimensions of each of the plurality of cells 1 is defined by the plurality of dimensions of the plurality of rods 2 comprising each of the plurality of cells 1. As such, the plurality of dimensions of each of the plurality of cells 1 is altered in accordance with a modification of the plurality of rods 2 that comprise each of the plurality of cells 1. Additionally, each of the plurality of cells 1 has a stiffness. The stiffness of each of the plurality of cells 1 is a function of the plurality of dimensions of each of the plurality of cells 1. Accordingly, the stiffness of each of the plurality of cells 1 is a function of the plurality of dimensions of each of the plurality of rods 2 that comprise each of the plurality of cells 1. As such, the stiffness of each of the plurality of cells 1, may be adjusted through altering the plurality of dimensions of each of the plurality of cells 1 by altering the plurality of dimensions of each of the plurality of rods 2 that comprise each of the plurality of cells 1. It is contemplated that each cell of the plurality of cells 1 may have unique dimensions providing a unique stiffness. Additionally, it is contemplated that one or more cells of the plurality of cells 1 may have dimensions that are equivalent to one or more other cells of the plurality of cells 1, such that a set of cells of the plurality of cells 1 are provided with an equal stiffness.

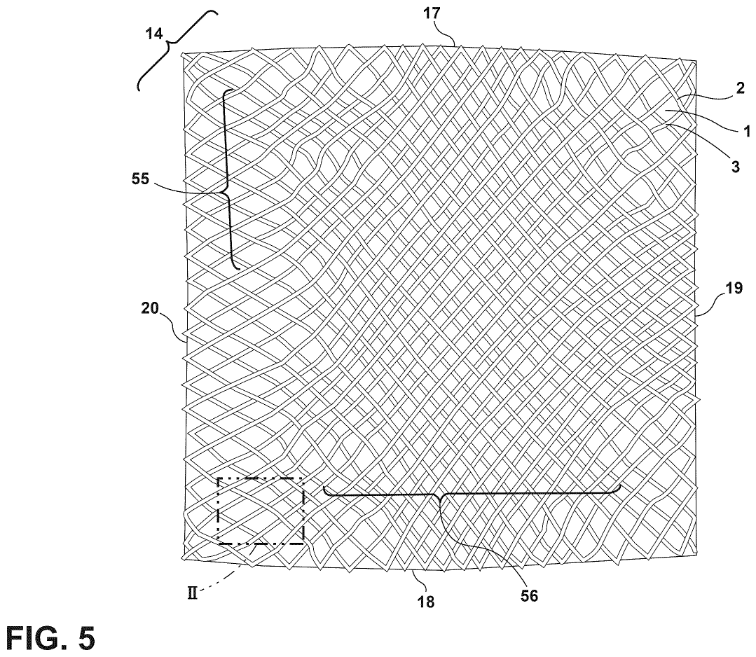

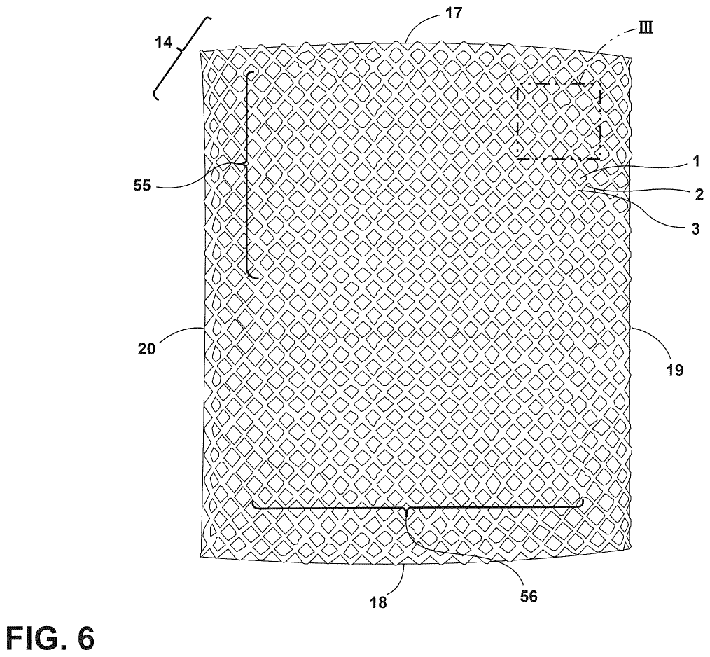

FIG. 5 shows a cross-sectional view of the vehicle cushion component 21 of FIG. 2 taken at line I, showing a first embodiment of the scaled stiffness gradient 50 of the lattice cell structure 14. FIG. 6 shows a cross-sectional view of the vehicle cushion component of FIG. 2 taken at line I, showing a second embodiment of the scaled stiffness gradient 50 of the lattice cell structure 14. Referring now to FIG. 1, FIG. 5, and FIG. 6, the dimensions of the lattice cell structure 14 are defined by a first surface 15, a second surface 16, a first end 17, a second end 18, a first side 19, and a second side 20. A depth of the lattice cell structure 14 is defined by the distance between the first surface 15 and the second surface 16. A length of the lattice cell structure 14 is defined by the distance extending between the first end 17 and the second end 18. A width of the lattice cell structure 14 is defined by the distance extending between the first side 19 and the second side 20. The cooperation of the first surface 15, the second surface 16, the first end 17, the second end 18, the first side 19, and the second side 20 provide the lattice cell structure 14 with an interior with a volume. The interior of the lattice cell structure 14 is filled with the plurality of cells 1 defined by the cooperation of the plurality of rods 2 and the plurality of nodes 3.

FIG. 7 shows a sectional view of the vehicle cushion component 21 coupled with a vehicle seat base. As shown in FIG. 7, the lattice cell structure 14 has a stiffness gradient 50 which provides the vehicle cushion component 21 with a variable degree of stiffness across a touch surface 60 of the vehicle cushion component 21. The stiffness gradient 50 provides the lattice cell structure 14 with a variable degree of stiffness, wherein portions of the lattice cell structure 14 exert unique responses to a force applied against the lattice cell structure 14. As shown in FIG. 5, FIG. 6, and FIG. 7, the stiffness gradient 50 is comprised of a depth gradient 54, a length gradient 55, and a width gradient 56.

Referring again to FIG. 5 and FIG. 6, the width gradient 56 extends along the width of the lattice cell structure 14. The width gradient 56 provides a variable degree of stiffness to resist a force vector with either a direction of magnitude exerted from the first side 19 of the lattice cell structure 14 to the second side 20 of the lattice cell structure 14 or a direction of magnitude exerted from the second side 20 of the lattice cell structure 14 to the first side 19 of the lattice cell structure 14. As such, the width gradient 56 provides variable rates of compression across the width of the lattice cell structure in response to a force exerted in the direction of either the first side 19 of the lattice cell structure 14 or the second side 20 of the lattice cell structure 14. The variable stiffness of the width gradient 56 is provided by the interplay of the plurality of cells 1 that extend between the first side 19 of the lattice cell structure 14 and the second side 20 of the lattice cell structure 14, wherein the plurality of cells 1 comprises of one or more cells with unique dimensions to provide the width gradient 56. For example, as an exerted vector of force is directed from the first side 19 of the lattice cell structure 14 to the second side 20 of the lattice cell structure 14, the plurality of cells 1 extending between the first side 19 and the second side 20 are configured to compress at different rates, providing the lattice cell structure 14 with a width gradient 56 that extends between the first side 19 of the lattice cell structure 14 and the second side 20 of the lattice cell structure 14.

Referring again to FIG. 5 and FIG. 6, the length gradient 55 extends along the length of the lattice cell structure 14. The length gradient 55 provides a variable degree of stiffness to resist a force vector with either a direction of magnitude exerted from the first end 17 of the lattice cell structure 14 to the second end 18 of the lattice cell structure 14 or a direction of magnitude exerted from the second end 18 of the lattice cell structure 14 to the first end 17 of the lattice cell structure. As such, the length gradient 55 provides variable rates of compression across the length of the lattice cell structure 14 in response to a force exerted in the direction of either the first end 17 of the lattice cell structure 14 or the second end 18 of the lattice cell structure 14. The variable stiffness of the length gradient 55 is provided by the interplay of the plurality of cells 1 that extend between the first end 17 of the lattice cell structure 14 and the second end 18 of the lattice cell structure 14, wherein the plurality of cells 1 comprises of one or more cells with unique dimensions to provide the length gradient 55. For example, as an exerted vector of force is directed from the first end 17 of the lattice cell structure 14 to the second end 18 of the lattice cell structure 14, the plurality of cells 1 extending between the first end 17 and the second end 18 are configured to compress at different rates, providing the lattice cell structure 14 with a length gradient 55 that extends between the first end 17 of the lattice cell structure 14 and the second end 18 of the lattice cell structure 14.

Referring now to FIG. 7, the depth gradient 54 extends along the depth of the lattice cell structure 14. The depth gradient 54 provides a variable degree of stiffness to resist a force vector with either a direction of magnitude exerted from the first surface 15 of the lattice cell structure 14 to the second surface 16 of the lattice cell structure 14 or a direction of magnitude exerted from the second surface 16 of the lattice cell structure 14 to the first surface 15 of the lattice cell structure 14. As such, the depth gradient 54 provides variable rates of compression across the depth of the lattice cell structure 14 in response to a force exerted in the direction of either the first surface 15 of the lattice cell structure 14 or the second surface 16 of the lattice cell structure 14. The variable stiffness of the depth gradient 54 is provided by the interplay of the plurality of cells 1 that extend between the first surface 15 of the lattice cell structure 14 and the second surface 16 of the lattice cell structure 14, wherein the plurality of cells 1 comprises of one or more cells with unique dimensions. For example, as an exerted vector of force is directed from the first surface 15 of the lattice cell structure 14 to the second surface 16 of the lattice cell structure 14, the plurality of cells extending between the first surface 15 and the second surface 16 are configured to compress at different rates, providing the lattice cell structure 14 with a depth gradient 54 that extends between the first surface 15 of the lattice cell structure 14 and the second surface 16 of the lattice cell structure. Additionally, it is contemplated that the plurality of cells 1 closest to the first surface 15 of the lattice cell structure 14 have a first stiffness and the plurality of cells 1 closest to the second surface 16 of the lattice cell structure 14 have a second stiffness, wherein the first stiffness is less than the second stiffness. Accordingly, when the second surface 16 is proximal to a vehicle component and the first surface 15 is proximal to a user, the plurality of cells 1 closest to the first surface 15 will compress prior in time to the compression of the plurality of cells 1 closest to the second surface 16 upon impact by a user against the vehicle cushion component 21. As such, the reaction force exerted by the vehicle cushion component 21 against the user during the impact will be lessened, as the plurality of cells 1 closest to the first surface 15 will compress upon impact, absorbing the impact of the user, prior to the compression of the plurality of cells 1 closest to the second surface 16.

Referring still to FIG. 7, the stiffness gradient 50 of the lattice cell structure 14 is provided through the interplay of the depth gradient 54, the length gradient 55, and the width gradient 56. As a force is exerted against the lattice cell structure 14, the lattice cell structure 14 resists the force in accordance with the resistances provided by the depth gradient 54, the length gradient 55, and the width gradient 56. As such, the touch surface 60 of the vehicle cushion component 21 may be provided with a variable degree of stiffness as a function of the overall stiffness gradient 50 of the lattice cell structure 14.

Referring still to FIG. 7, the variable degree of stiffness provided by the touch surface 60 of the vehicle cushion component 21 may be customized to the needs of a specific user of the vehicle. Specifically, the depth gradient 54, the length gradient 55, and the width gradient 56 may be customized through adjusting the plurality of dimensions of the plurality of rods 2 that comprise the plurality of cells 1 such that the resulting stiffness gradient is custom to the user. In other words, the plurality of dimensions of the plurality of cells is adjusted to provide the stiffness gradient 50 that is custom to the user. It is contemplated that when the stiffness gradient 50 of the lattice cell structure 14 is customized, the touch surface 60 of the vehicle cushion component 21 can provide unique resistances to a force exerted against the touch surface 60 by a user. As such, the stiffness gradient 50 can provide to the touch surface 60 of the vehicle cushion component 21 areas that are less resistant to a force exerted by the user, so that a joint or other pressure point of a body of the user can be more comfortably accommodated. Additionally, it is contemplated that the stiffness gradient 50 can provide to the touch surface 60 of the vehicle cushion component 21 areas that are more resistant to a force exerted by the user, so that portions of the user's body in need of support can be adequately supported.

The process by which the vehicle cushion component 21 and the stiffness gradient 50 is manufactured will be described. The manufacturing process, as noted above, includes an additive manufacturing technique for the creation of the monolithic webbing 40 that comprises the lattice cell structure 14. Numerous additive manufacturing techniques are known, including, but not limited to, a light-polymerized 3D printer, a laser sintering printer, and a fused filament fabrication printer. These processes may include the deposition of the build material in a layer-by-layer manner to manufacture an overall product. Other processes may include a liquid build material that is provided in a vat and exposed to an energy source Such additive manufacturing processes are also known to include 3D printers that use digital light projection, such as used in a stereolithography technique, or binder jetting to fuse layers of curable substrates with applications of light or heat from an energy source.

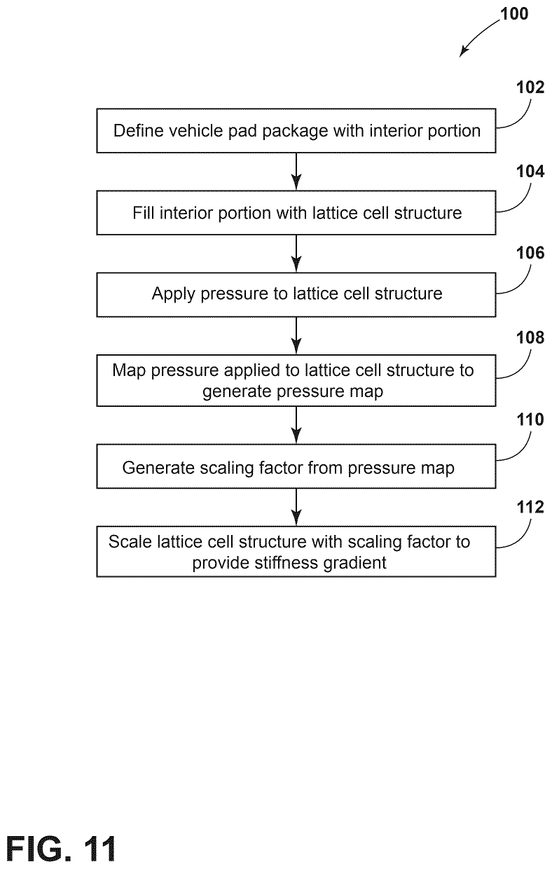

Referring now to FIG. 11, a method 100 of manufacturing a vehicle cushion component 21 with a stiffness gradient 50 is shown and includes the following steps. In an initial step 102 a vehicle pad package with an interior portion is defined. The vehicle pad package comprises a template containing an interior, wherein the dimensions of the interior of the vehicle pad package corresponds with the desired dimensions of the lattice cell structure 14. In step 104, the interior portion of the vehicle pad package is filled with the monolithic webbing 40 comprising the lattice cell structure 14. In step 106, pressure is applied to the lattice cell structure 14. Specifically, a seat testing robot may be provided and programmed to exert an equivalent set of pressures against the lattice cell structure 14 as a set of pressures contained within a template pressure map provided to the seat testing robot. The template pressure map may comprise a pressure map generated by a specific customer exerting a force against a template vehicle cushion component. Additionally, it is contemplated that the template pressure may be a pressure map generated in accordance with a statistical average pressure applied to the template vehicle cushion component by a sample of people within a customer demographic set associated with a user. Also, the pressure map may represent a maximum pressure applied to the template vehicle cushion component over a time interval in which pressure was applied to the template vehicle cushion component. It is also contemplated that the pressure map may be an off-road pressure map, representative of a pressure applied to the template vehicle cushion component by a user when the user engages in off-roading activity. In step 108, the pressure applied by the seat testing robot is used to generate a scaling pressure map. The scaling pressure map is contemplated as representative of the reaction force provided by the lattice cell structure 14 in response to the force exerted against the lattice cell structure 14 by the seat testing robot programmed to exert a pressure equivalent with one of the plurality of template pressure maps. As such, the scaling pressure map represents the force recorded in one of the plurality of template pressure maps, as applied to the lattice cell structure 14. In step 110, a scaling factor is generated in accordance with the scaling pressure map. The scaling factor is contemplated as an algorithm configured to provide the lattice cell structure 14 with a stiffness gradient 50 adapted to the needs of the user of the vehicle cushion component 21. Specifically, the scaling factor modifies one or more of the plurality of dimensions of one or more of the plurality of rods 2 that comprise each cell of the plurality of cells 1 such that one or more of the plurality of cells 1 has a unique dimension with a unique stiffness. Accordingly, an application of the scaling factor provides the lattice cell structure 14 with a scaled stiffness gradient 50 that produces a vehicle cushion component 21 with a touch surface 60 compliant to the needs of the scaling pressure map. It is contemplated that the scaling factor is produced in accordance with the scaling pressure map, wherein the pressure values provided on the scaling pressure map are converted to a load using the formula F=P/A. Next, the force values are transformed through a min-max normalization to values between 0 and 1. Last, the normalized force values are applied to scale the lattice cell structure 14 using a programmable software such as, but not limited to, nTop [tm] in step 112 of the method.

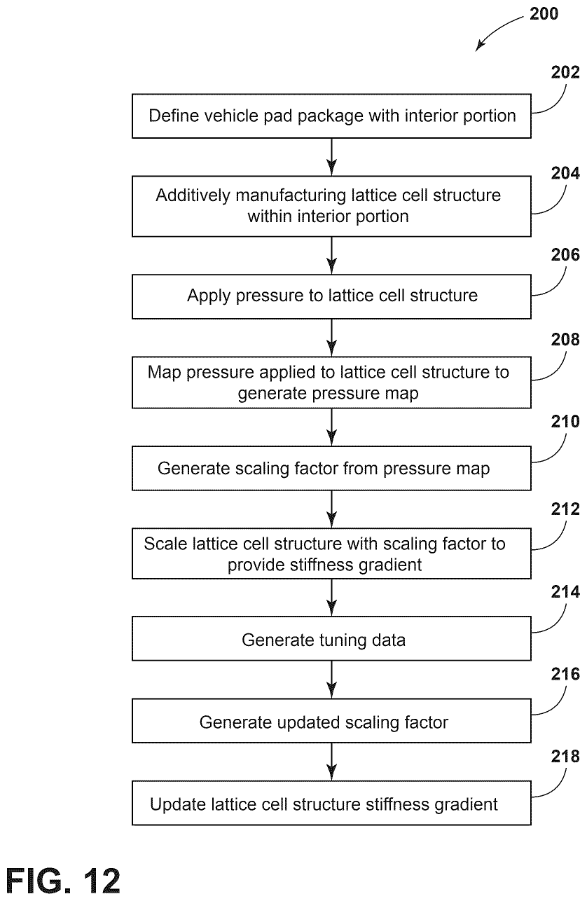

Referring now to FIG. 12, a method 200 of manufacturing a vehicle cushion component 21 with a stiffness gradient 50 is shown and includes, in addition to the steps of FIG. 11 (202-212), the step 214 of generating tuning data. Tuning data is data reflecting a comparison between the stiffness gradient 50 of the lattice cell structure 14 when coupled with one or more vehicle components and a stiffness gradient 50 of the lattice cell structure 14 when uncoupled from the one or more vehicle components. Specifically, to collect tuning data, the stiffness gradient 50 of the lattice cell structure 14 is measured and then compared to the stiffness gradient 50 of the lattice cell structure 14 when the lattice cell structure 14 is coupled with one or more vehicle components. The tuning data reflects changes in the stiffness gradient 50 of the lattice cell structure 14 when the lattice cell structure 14 is coupled with one or more vehicle components. In step 216, the scaling factor is updated in accordance with the original scaling factor and the tuning data. Specifically, an updated scaling factor is generated and is configured to provide a calibration to the stiffness gradient 50 of the lattice cell structure 14 to adjust for changes that occur to the stiffness gradient 50 of the lattice cell structure 14 when the lattice cell structure 14 is coupled with one or more vehicle components. In step 218, the stiffness gradient of the lattice cell structure 14 is updated through the application of the updated scaling factor. It is contemplated that while the stiffness gradient 50 of the lattice cell structure 14 may be updated to reflect changes associated with the coupling of the lattice cell structure 14 to one or more vehicle components, the range of variable stiffnesses provided by the touch surface 60 of the vehicle cushion component 21 will not change. In other words, the method of FIG. 12 adjusts the stiffness gradient 50 of the lattice cell structure 14 to maintain the same range of variable stiffness provided by the touch surface 60 of the vehicle cushion component 21 when the lattice cell structure 14 is coupled with one or more vehicle components as when the lattice cell structure 14 is uncoupled from one or more vehicle components. Additionally, it is contemplated that the method of FIG. 12 may be applied to adjust the stiffness gradient 50 of the lattice cell structure 14 when the lattice cell structure 14 is coupled with the top cover 22 and the bottom cover 23 to maintain an equivalent range of variable stiffness provided by the touch surface 60 of the vehicle cushion component 21.

Referring now to FIG. 5, a top-down view of a cross-section of the vehicle cushion component 21 of FIG. 2 at Line 1 is shown. This cross-section shows a single cell layer of the lattice cell structure 14 provided with a stiffness gradient 50 that has been scaled in accordance with a first embodiment. In the first embodiment, the scaled stiffness gradient 50 is provided through modifying a density of the lattice cell structure 14 through modifying the volume of one or more of the plurality of cells 1, through modifying one or more of the plurality of dimensions of the plurality of rods 2. It should be understood that the cell layer shown is one of a plurality of cell layers that can comprise the lattice cell structure 14. The cell layer shown is defined by a first end 17, a second end 18, a first side 19, and a second side 20 which cooperate to define an interior of the cell layer. The interior of the cell layer is comprised of a plurality of cells 1 wherein each of the plurality of cells 1 is comprised of a plurality of rods 2 and a plurality of nodes 3. The cell layer shown is provided with a length gradient 55 and a width gradient 56 which cooperate with a depth gradient (not shown) to provide the cell layer of the lattice cell structure 14 with a stiffness gradient 50. The stiffness gradient 50 has been scaled in accordance to either a scaling factor or an updated scaling factor. In FIG. 5, the stiffness gradient 50 has been scaled through adjusting the number of the plurality of cells 1 disposed within the interior of the cell layer. In other words, the density of the cell layer, and accordingly, the lattice cell structure 14 has been adjusted to provide the lattice cell structure 14 with a scaled stiffness gradient 50. The number of the plurality of cells 1 disposed within the interior of the cell layer may be adjusted through altering the plurality of dimensions of the plurality of cells 1 such that one or more of the plurality of cells 1 have a unique volume. Specifically, the plurality of dimensions of one or more of the plurality of rods 2 that comprise each of the plurality of cells 1 may be adjusted to provide one or more of the plurality of cells 1 with a unique volume. The volume of each cell of the plurality of cells 1 is defined by an interior of each of the plurality of cells 1. The interior of each of the plurality of cells 1 is defined by the plurality of dimensions of the plurality of rods 2 that comprise each of the plurality of cells 1. Any of the plurality of dimensions of the plurality of rods 2 may be modified, including the length dimension 10, the curvature dimension 11, the contact angle dimension 8, and the thickness dimension 6 to provide one or more of the plurality of cells 1 with a unique interior with a corresponding unique volume. To provide a scaled stiffness gradient through altering the density of the lattice cell structure, the plurality of dimensions of one or more of the plurality of rods 2 is altered in accordance with either the scaling factor or the updated scaling factor to provide one or more of the plurality of cells 1 with a unique volume. Accordingly, the alteration of the plurality of dimensions of one or more of the plurality of rods 2 through the application of either the scaling factor or the updated scaling factor to alter the lattice cell structure 14 density, may produce a scaled stiffness gradient 50 that provides a touch surface 60 of the vehicle cushion component 21 with a variable stiffness unique to the user. Additionally, the stiffness gradient 50 of the lattice cell structure 14 may be scaled through increasing the density of the lattice cell structure 14 through modifying the number of cell layers that comprise the lattice cell structure 14.

Referring now to FIG. 6, a top-down view of a cross-section of the vehicle cushion component 21 of FIG. 2 at Line 1 is shown. This cross-section shows a single cell layer of the lattice cell structure 14 provided with a stiffness gradient that has been scaled in accordance with a second embodiment. In the second embodiment, the scaled stiffness gradient is provided through modifying the thickness dimension 6 of one or more of the plurality of rods 2. It should be understood that the cell layer shown is one of a plurality of cell layers that may comprise the lattice cell structure 14. The cell layer shown is defined by a first end 17, a second end 18, a first side 19, and a second side 20 which cooperate to define an interior of the cell layer. The interior of the cell layer is comprised of the plurality of cells 1, wherein each of the plurality of cells 1 are comprised of the plurality of rods 2 and the plurality of nodes 3. The cell layer shown is provided with a length gradient 55 and a width gradient 56 which cooperate with a depth gradient (not shown) to provide the cell layer of the lattice cell structure 14 with a stiffness gradient 50. The stiffness gradient 50 has been scaled in accordance to either a scaling factor or an updated scaling factor. In FIG. 6, the stiffness gradient 50 has been scaled through adjusting the thickness dimension 6 of one or more of the plurality of rods 2. The thickness dimension 6 of one or more of the plurality of rods 2 is adjusted to provide one or more of the plurality of cells 1 with a unique stiffness. As such, the interplay between each of the plurality of cells 1, wherein one or more of the plurality of cells 1 has a unique stiffness provides the lattice cell structure 14 with a stiffness gradient 50. Accordingly, the alteration of the thickness dimension 6 of one or more of the plurality of rods 2 through the application of either the scaling factor or the updated scaling factor may produce a scaled stiffness gradient 50 configured to provide a touch surface 60 of the vehicle cushion component 21 with a variable stiffness unique to the user.

Referring to both FIG. 5 and FIG. 6, it is contemplated that the stiffness gradient 50 of the lattice cell structure 14 may be scaled in accordance with either the scaling factor or the updated scaling factor through either modifying the density of the lattice cell structure 14, modifying the thickness dimension 6 of one or more of the plurality of rods 2, or through a combination of both modifications. Accordingly, a lattice cell structure 14 may have a scaled stiffness gradient provided through both modifying the density of the lattice cell structure 14 and modifying the thickness dimension 6 of one or more of the plurality of rods 2. Additionally, it is contemplated that the scaled stiffness gradient may be provided through adjusting one or more of the plurality of dimensions of one or more of the plurality of rods 2 without modifying the density of the lattice cell structure 14.

Additionally, it is contemplated that an ornamentation piece may be embedded within the touch surface 60 of the vehicle cushion component 21. The ornamentation piece can comprise a static emblem or the ornamentation piece may comprise a lighted emblem, wherein the lighted emblem is comprised of a translucent material coupled with an illumination means configured to provide illumination to the lighted emblem. It is contemplated that the touch surface 60 surrounding the ornamental piece may be adjusted to support the ornamentation piece. Specifically, a first portion of the touch surface 60 surrounding and supporting the ornamentation piece may have a first touch stiffness that has a degree of stiffness greater than a degree of stiffness of a second touch stiffness provided by a second portion of the touch surface 60 that surrounds the first portion of the touch surface 60. Accordingly, the first portion of the touch surface 60 provides a degree of support to the ornamentation piece. As such, the stiffness gradient 50 of the lattice cell structure 14 is modified to provide support to the ornamentation piece while maintaining a touch surface 60 compliant with the needs of the user. Additionally, it is contemplated that step 214 of the method depicted in FIG. 12 may be adjusted to generate tuning data, wherein the tuning data reflects the stiffness gradient 50 of the lattice cell structure 14 and the stiffness gradient 50 of the lattice cell structure 14 when coupled with one or more vehicle components, wherein the one or more vehicle components is the ornamentation piece. Accordingly, the stiffness gradient 50 of the lattice cell structure 14 can be updated to reflect a change necessary to maintain a touch surface 60 with a variable stiffness unique to the user when the touch surface 60 is providing support to the ornamentation piece.

Additionally, it is contemplated that the lattice cell structure 14 may provide support for heating, ventilation, and air conditioning components (HVAC) embedded within the lattice cell structure 14. The embedded HVAC components may comprise but are not limited to comprising of ductwork, vent registers, and cooling and heating passages configured to carry air or liquid mediums for cooling or heating a user. Further, the lattice cell structure may be adjusted such that an embedding portion of the lattice cell structure which supports the HVAC components has an embedding stiffness which provides a greater stiffness than a non-embedding stiffness of a non-embedding portion of the lattice cell structure that does not surround the HVAC components. As such, the stiffness gradient 50 of the lattice cell structure 14 is modified to provide support to the HVAC components while maintaining a touch surface 60 compliant with the needs of the user. Additionally, it is contemplated that step 214 of the method depicted in FIG. 12 may be adjusted to generate tuning data, wherein the tuning data reflects the stiffness gradient of the lattice cell structure 14 and the stiffness gradient of the lattice cell structure 14 when coupled with one or more vehicle components, wherein the one or more vehicle components is one or more embedded HVAC components. Accordingly, the stiffness gradient 50 of the lattice cell structure 14 can be updated to reflect a change necessary to maintain a touch surface 60 with a variable stiffness unique to the user when the lattice cell structure 14 is providing support to the one or more embedded HVAC components.

Additionally, it is contemplated that the lattice cell structure 14 may provide support for lighting systems embedded within the lattice cell structure 14. The lattice cell structure may be adjusted such than a lighting embedding portion of the of the lattice cell structure 14 which supports the lighting system has a lighting embedding stiffness which provides a greater stiffness than a non-lighting embedding stiffness of a non-lighting embedding portion of the lattice cell structure 14 that does not surround the lighting system. As such, the stiffness gradient 50 of the lattice cell structure 14 is modified to provide support to the lighting system while maintaining a touch surface 60 compliant with the needs of the user. Additionally, it is contemplated that step 214 of the method depicted in FIG. 12 may be adjusted to generate tuning data, wherein the tuning data reflects the stiffness gradient of the lattice cell structure 14 and the stiffness gradient of the lattice cell structure 14 when coupled with one or more vehicle components, wherein the one or more vehicle components is one or more embedded lighting systems. Accordingly, the stiffness gradient 50 of the lattice cell structure 14 can be updated to reflect a change necessary to maintain a touch surface 60 with a variable stiffness unique to the user when the lattice cell structure 14 is providing support to the one or more embedded lighting components.

Additionally, it is contemplated that the lattice cell structure 14 may be configured to provide sound traveling components integrally formed within the lattice cell structure 14. A sound enhancement component comprises any structure configured to promote the transmission of sound waves and vibrations to a user of the vehicle cushion component 21. The sound enhancing component may be provided through the cooperation of the plurality of cells 1. As such, the sound enhancement component may be comprised of one or more of the plurality of cells 1. In an exemplary embodiment, the sound enhancement component of the lattice cell structure 14 is configured to transmit sound waves and vibrations generated by an engine of the vehicle to the user. Also, it is contemplated that the sound traveling components may be an embedded sound traveling component that is not integral with the lattice cell structure 14, but is embedded within the lattice cell structure 14. Additionally, it is contemplated that step 214 of the method depicted in FIG. 12 may be adjusted to generate tuning data, wherein the tuning data reflects the stiffness gradient 50 of the lattice cell structure 14 and the stiffness gradient of the lattice cell structure 14 when coupled with one or more vehicle components, wherein the one or more vehicle components is one or more sound traveling components. Accordingly, the stiffness gradient 50 of the lattice cell structure 14 can be updated to reflect a change necessary to maintain a touch surface 60 with a variable stiffness unique to the user when the lattice cell structure 14 is providing support to the one or more sound traveling components.

Additionally, it is contemplated that the lattice cell structure 14 may be configured to provide noise reduction components integrally formed within the lattice cell structure 14. A noise reduction component comprises any structure configured to reduce the effect of sound waves and vibrations transmitted to the vehicle cushion component 21. The noise reduction component may be provided through the cooperation of the plurality of cells 1. As such, the noise reduction component may be comprised of one or more of the plurality of cells 1. In an exemplary embodiment, the noise reduction component of the lattice cell structure 14 is configured to reduce the transmission of sound waves and vibrations generated by the passage of the vehicle through the atmosphere. Also, it is contemplated that the noise reduction components may be embedded noise reduction components that are not integral with the lattice cell structure 14 but are embedded within the lattice cell structure 14. Additionally, it is contemplated that step 214 of the method depicted in FIG. 12 may be adjusted to generate tuning data, wherein the tuning data reflects the stiffness gradient 50 of the lattice cell structure 14 and the stiffness gradient 50 of the lattice cell structure 14 when coupled with one or more vehicle components, wherein the one or more vehicle components is one or more noise reduction components. Accordingly, the stiffness gradient 50 of the lattice cell structure 14 can be updated to reflect a change necessary to maintain a touch surface 60 with a variable stiffness unique to the user when the lattice cell structure 14 is providing support to the one or more noise reduction components.

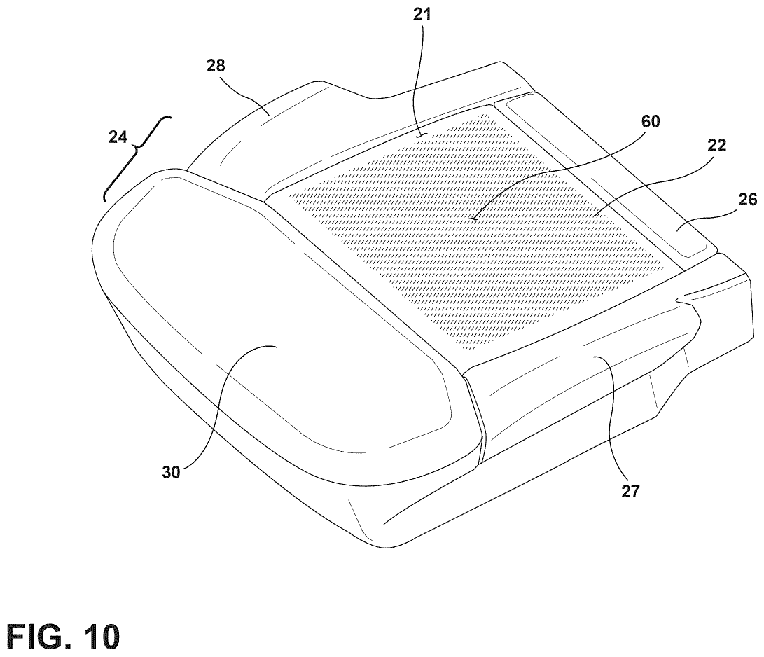

Referring now to FIG. 10, a vehicle cushion component 21 is shown coupled with a seat base 24 of a vehicle. The seat base 24 comprises a rear cushion 26 a front cushion 30, a first base flange 27, and a second base flange 28. The vehicle cushion component 21 is coupled with an interior space defined by the rear cushion 26, the front cushion 30, the first base flange 27, and the second base flange 28. Specifically, the first end 17 of the lattice cell structure 14 is in contact with the rear cushion 26, the second end 18 of the lattice cell structure 14 is in contact with the front cushion 30, the first side 19 of the lattice cell structure is in contact with the first base flange 27 and the second side 20 of the lattice cell structure 14 is in contact with the second base flange 28. The top cover 22 of the vehicle cushion component is configured to be disposed towards a user of the seat base 24, such that the touch surface 60 of the vehicle cushion component 21 may contact the user.

It is further contemplated that the vehicle cushion component 21 may be coupled with a plurality of other vehicle components, including, but not limited to a vehicle seat back, a vehicle door armrest, a vehicle instrument panel topper, or a vehicle door top, wherein the vehicle door top is a surface of a vehicle window housing configured to be in contact with the user.

According to a first aspect of the present disclosure, a vehicle cushion component is provided, comprising a lattice cell structure, wherein the lattice cell structure is comprised of a plurality of rods and a plurality of nodes, wherein the plurality of rods and the plurality of nodes cooperate to define a plurality of cells. The plurality of cells includes a plurality of dimensions, wherein a dimension of the plurality of dimensions of one or more cells of the plurality of cells is modified in accordance with a scaling factor to define a stiffness gradient for the lattice cell structure. Embodiments of the first aspect of the present disclosure can include any one or a combination of the following features:
The scaling factor is derived from data provided in a pressure map taken of the lattice cell structure.
The scaling factor is derived from data produced through a tuning process, wherein the tuning process compares the stiffness gradient of the lattice cell structure when coupled with one or more vehicle components with the stiffness gradient of the lattice cell structure when uncoupled from one or more vehicle components.
The scaling factor is derived from data provided in a pressure map taken of the lattice cell structure, wherein the pressure map is customized in accordance with a pressure applied by a user seated on the lattice cell structure of the vehicle cushion component.
The scaling factor is derived from data provided in a pressure map taken of the lattice cell structure, wherein the pressure map is generated in accordance with a statistical average pressure applied to the lattice cell structure by a sample of users within a customer demographic set.
The scaling factor is derived from data provided in a pressure map wherein the pressure map includes a maximum pressure applied to the lattice cell structure over a time interval.
The scaling factor is derived from data produced through a tuning process, wherein the tuning process compares the stiffness gradient of the lattice cell structure when coupled with one or more vehicle components with the stiffness gradient of the lattice cell structure when uncoupled from one or more vehicle components, wherein the one or more vehicle components comprises components of a vehicle seating assembly.
The scaling factor is derived from data produced through a tuning process, wherein the tuning process compares the stiffness gradient of the lattice cell structure when coupled with one or more vehicle components with the stiffness gradient of the lattice cell structure when uncoupled from one or more vehicle components, wherein the one or more vehicle components comprises a cover for the lattice cell structure.
One of the plurality of dimensions of the plurality of cells includes a diameter of one or more of the plurality of rods.
One of the plurality of dimensions of the plurality of cells includes a contact angle of one or more of the plurality of rods.
One of the plurality of dimensions of the plurality of cells includes a length of one or more of the plurality of rods.
The lattice cell structure is provided with the stiffness gradient through modifying a density of the lattice cell structure in accordance with the scaling factor.
The lattice cell structure is comprised of a plurality of layers, wherein the plurality of layers is comprised of the plurality of cells.
The lattice cell structure is generated through an additive manufacturing process.

According to a second aspect of the present disclosure a method for manufacturing a vehicle component includes the step of defining a vehicle pad package with an interior portion and filling the interior portion of the vehicle pad package with a lattice cell structure. Next, pressure is applied to the lattice cell structure. The pressure applied to the lattice cell structure is mapped to generate a pressure map. A scaling factor is generated from the pressure map taken of the lattice cell structure and the lattice cell structure is scaled in accordance with the scaling factor to provide the lattice cell structure with a stiffness gradient. Embodiments of the second aspect of the present disclosure can include any one or a combination of the following features:
The scaling factor is derived from data provided in a pressure map taken of the lattice cell structure, wherein the pressure map is customized in accordance with a pressure applied by a user seated on the lattice cell structure of the vehicle cushion component.
The scaling factor is derived from data provided in a pressure map taken of the lattice cell structure, wherein the pressure map is generated in accordance with a statistical average pressure applied to the lattice cell structure by a sample of users within a customer demographic set.

According to a third aspect of the present disclosure a method for manufacturing a vehicle component includes the step of defining a vehicle pad package with an interior portion and filling the interior portion of the vehicle pad package with a lattice cell structure. Next, pressure is applied to the lattice cell structure. The pressure applied to the lattice cell structure is mapped to generate a pressure map. A scaling factor is generated from the pressure map taken of the lattice cell structure and the lattice cell structure is scaled in accordance with the scaling factor to provide the lattice cell structure with a stiffness gradient. Tuning data is generated from a comparison between a stiffness gradient of the lattice cell structure when coupled with one or more vehicle components and a stiffness gradient of the lattice cell structure when uncoupled from the one or more vehicle components. An updated scaling factor is generated in accordance with the tuning data and the scaling factor and the stiffness gradient is updated with the updated scaling factor to provide the lattice cell structure with an updated stiffness gradient. Embodiments of the third aspect of the present disclosure can include any one or a combination of the following features:
The lattice cell structure is scaled in accordance with either the scaling factor or the updated scaling factor by modifying a dimension of one or more of a plurality of cells that comprise the lattice cell structure.
The lattice cell structure is scaled in accordance with either the scaling factor or the updated scaling factor by modifying the density of the lattice cell structure.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle cushion component, comprising:
a lattice cell structure comprised of a plurality of rods and a plurality of nodes, wherein the plurality of rods and the plurality of nodes cooperate to define a plurality of cells wherein the plurality of cells include a plurality of dimensions, and further wherein a dimension of the plurality of dimensions of one or more cells of the plurality of cells is modified in accordance with a scaling factor to define a stiffness gradient for the lattice cell structure.

2. The vehicle cushion component of claim 1, wherein the scaling factor is derived from data provided in a pressure map taken of the lattice cell structure.

3. The vehicle cushion component of claim 1, wherein the scaling factor is derived from data produced through a tuning process, wherein the tuning process compares the stiffness gradient of the lattice cell structure when coupled with one or more vehicle components with the stiffness gradient of the lattice cell structure when uncoupled from the one or more vehicle components.

4. The vehicle cushion component of claim 2, wherein the pressure map is customized in accordance with a pressure applied by a user seated on the lattice cell structure of the vehicle cushion component.

5. The vehicle cushion component of claim 2, wherein the pressure map is generated in accordance with a statistical average pressure applied to the lattice cell structure by a sample of users within a customer demographic set.

6. The vehicle cushion component of claim 2, wherein the pressure map includes a maximum pressure applied to the lattice cell structure over a time interval.

7. The vehicle cushion component of claim 3, wherein the tuning process compares the stiffness gradient of the lattice cell structure when coupled with one or more components of a vehicle seating assembly with the stiffness gradient of the lattice cell structure when uncoupled with one or more vehicle components of the vehicle seating assembly.

8. The vehicle cushion component of claim 3, including:
a cover disposed along a first surface of the lattice cell structure covering the lattice cell structure, wherein the tuning process compares the stiffness gradient of the lattice cell structure when coupled with the cover with the stiffness gradient of the lattice cell structure when uncoupled with the cover.

9. The vehicle cushion component of claim 1, wherein one of the dimensions of the plurality of dimensions of the one or more cells of the plurality of cells includes a thickness dimension of one or more rods of the plurality of rods.

10. The vehicle cushion component of claim 1, wherein one of the dimensions of the plurality of dimensions of the one or more cells of the plurality of cells includes a contact angle dimension of one or more rods of the plurality of rods.

11. The vehicle cushion component of claim 1, wherein one of the dimensions of the plurality of dimensions of the one or more cells of the plurality of cells includes a length dimension of one or more rods of the plurality of rods.

12. The vehicle cushion component of claim 1, wherein a density of the lattice cell structure is modified in accordance with the scaling factor to provide the lattice cell structure with the stiffness gradient.

13. The vehicle cushion component of claim 1, wherein the lattice cell structure is further comprised of a plurality of layers, wherein the plurality of layers is comprised of the plurality of cells.

14. The vehicle cushion component of claim 1, wherein the lattice cell structure is generated through an additive manufacturing process.

15. A method for manufacturing a vehicle cushion component, the method comprising the steps of:
defining a vehicle pad package with an interior portion;
filling the interior portion of the vehicle pad package with a lattice cell structure;
apply pressure to the lattice cell structure;
mapping the pressure applied to the lattice cell structure to generate a pressure map;
generating a scaling factor from the pressure map taken of the lattice cell structure; and
scaling the lattice cell structure in accordance with the scaling factor to provide the lattice cell structure with a stiffness gradient.

16. The method of claim 15, wherein the pressure map is customized in accordance with a pressure applied by a customer to the lattice cell structure.

17. The method of claim 15, wherein the pressure map is generated in accordance with a statistical average pressure applied to the lattice cell structure by a sample of people within a customer demographic set associated with a customer.

18. A method for manufacturing a vehicle cushion component, the method comprising the steps of:
defining a vehicle pad package with an interior portion;
additively manufacturing a lattice cell structure within the interior portion of the vehicle pad package;
apply a pressure to the lattice cell structure;
mapping the pressure applied to the lattice cell structure to generate a pressure map;
generating a scaling factor from the pressure map taken of the lattice cell structure;
scaling the lattice cell structure in accordance with the scaling factor to provide the lattice cell structure with a stiffness gradient;
generating tuning data from a comparison between a stiffness gradient of a lattice cell structure when coupled with one or more vehicle components and a stiffness gradient of the lattice cell structure when uncoupled from the one or more vehicle components;
generating an updated scaling factor in accordance with the tuning data and the scaling factor; and
updating the stiffness gradient with the updated scaling factor to provide the lattice cell structure with an updated stiffness gradient.

19. The method of claim 18, wherein the lattice cell structure is scaled in accordance with either the scaling factor or the updated scaling factor by modifying a dimension of one or more of a plurality of cells that comprise the lattice cell structure.

20. The method of claim 18, wherein the lattice cell structure is scaled in accordance with either the scaling factor or the updated scaling factor by modifying a density of the lattice cell structure.
